(19) United States
(12) Patent Application Publication
(10) Pub. No.: US 2009/0134582 A1
(43) Pub. Date: May 28, 2009

(54) Seal Assembly

(76) Inventor: Anthony Joseph Murray, Western Australia (AU)

Correspondence Address: BIRCH STEWART KOLASCH & BIRCH, PO BOX 747, FALLS CHURCH, VA, 22040-0747, US

(21) Appl. No.: 11/992,311

(22) PCT Filed: Sep. 21, 2006
(86) PCT No.: PCT/AU2006/001384

§ 371 Date: Jun. 24, 2008

(30) Foreign Application Priority Data
Sep. 22, 2005 (AU) 2005905225
Aug. 21, 2006 (AU) 2006904504

(51) Int. Cl. F16J 15/32; F16J 15/34

(52) U.S. Cl. 277/361; 277/387

(57) ABSTRACT

A centrifugal pump seal assembly (10) for forming a seal between an impeller (12) and its casing (14), the seal assembly (10) comprising at least one sealing member (20) supported on the casing (14) and being capable of movement to a position at which it sealingly contacts the impeller (14), the movement of the sealing member (20) being actuated by fluid pressure generated at the outlet side (18) of the casing (14), and wherein the seal is maintained by the continual fluid pressure applied to the sealing member (14) when the pump is in use.

### FIELD OF THE INVENTION

The present invention relates to seal assembly for forming a seal between a first and second member. More particularly, the present invention relates to a seal assembly for forming a seal between the impeller and casing of a centrifugal pump.

### BACKGROUND ART

Seal assemblies of various forms are required in many apparatus and are often required to form a seal between moving parts. Most seals are prone to wear and require regular servicing.

Pumps such as centrifugal pumps are one form of apparatus that utilise seals. In general, centrifugal pumps employ an impeller that rotates within a casing that has an inlet or suction side and an outlet or discharge side. Centrifugal pumps function optimally when the impeller and the casing are fully sealed. In this regard, centrifugal pumps rely on the rotation of the impeller within the casing to produce a reduction in pressure at the inlet which causes fluid to flow into the impeller. The fluid is then forced outwards by the impeller at increasing tangential velocity via the outlet.

Traditionally, wear rings are used to seal the impeller and the casing. In this regard, wear rings are positioned to seal the impeller and the casing at the inlet or suction side of the casing as well as at the opposite side or hub side of the casing.

Wear ring assemblies are fixed arrangements that include one ring revolving concentrically within another. One wear ring is attached to the impeller and one to the pump housing or casing. During use, friction causes the gap between the wear rings to increase. As the gap increases the seepage of fluid also increases to the point where pumping efficiency is reduced and the wear rings must be replaced.

The present invention seeks to overcome or at least partially reduce the problems discussed above. At the very least, the present invention seeks to provide an alternative to prior art seal assemblies.

### DISCLOSURE OF THE INVENTION

Thus, the present invention provides a seal assembly for forming a seal between a first member and a second member, at least one of said members being adapted for rotational movement relative to the other member, the seal assembly comprising a sealing means supported on one of the members and being adapted for movement to a position at which it sealingly contacts the other member, the movement of the sealing means being actuated by fluid pressure.

The relative rotational movement of the first and second members may be varied. For example, the first member may be stationary and the second member may be adapted for rotational movement relative to the first member or vice versa. Alternatively, both the first and second members may be adapted for rotational movement in such a way that there is relative rotational movement between said members.

The sealing means may be supported from either the first or the second member provided it is capable of forming a seal between said members upon actuation by fluid pressure. When the first member is stationary relative to the second member or vice versa, the sealing means is preferably supported from the stationary member.

Thus, the present invention also provides a seal assembly for forming a seal between a first member which is stationary and a second member which is adapted for rotational movement relative to said first member, the seal assembly comprising a sealing means supported on the first member and being adapted for movement to a position at which it sealingly contacts the second member, the movement of the sealing means being actuated by fluid pressure.

In one particular form, the seal assembly of the present invention may be applied to a centrifugal pump for pumping fluids. Centrifugal pumps may be of various forms and in their simplest form include an impeller that rotates within a casing. Centrifugal pump casings generally have an inlet side and an outlet side for the fluid being pumped, between which the impeller is located. The impeller draws fluid from the inlet side and discharges it through the outlet. As indicated above, to function properly the impeller and the casing must be sealed.

When the seal assembly of the present invention is used in a centrifugal pump, the first member may comprise the pump casing supporting the sealing means and the second member may be an impeller, where the sealing means is adapted for movement relative to the casing to sealingly contact the impeller. Indeed, the remainder of the description will be limited to the description of a seal assembly for a centrifugal pump. The following description is in no way to limit the generality of the preceding paragraphs.

Thus, the present invention also provides a centrifugal pump seal assembly for forming a seal between an impeller and its casing, the seal assembly comprising a sealing means supported on the casing and being capable of movement to a position at which it sealingly contacts the impeller, the movement of the sealing means being actuated by fluid pressure generated at the outlet side of the casing.

The seal assembly of the present invention may be adapted to form a seal at either or both of the inlet side and the opposite side or hub side of the casing. When the seal assembly is adapted to form a seal at either the inlet side or the opposite side of the casing the sealing means may comprise a sealing member. When the seal assembly is adapted to form a seal at both the inlet side and opposite side, the sealing means may comprise at least two sealing members, which are preferably identical.

The configuration of the sealing member is at least partially dependent on the configuration of the centrifugal pump to which the seal assembly is fitted and may be varied provided it is capable of forming a seal between the impeller and the casing. Further, the shape and configuration of the sealing member is also at least partially dependent on the shape and configuration of the impeller and more particularly the shape and configuration of the portion of the impeller at which the seal is to be made.

Preferably, the sealing member is adapted to sealingly contact the impeller in a fashion that allows it to compensate for wear in either or both of the sealing member and the portion of the impeller at which the seal is made when in use.

Thus, the present invention also provides a centrifugal pump seal assembly for forming a seal between an impeller and its casing, the seal assembly comprising at least one sealing member supported on the casing and being capable of movement to a position at which it sealingly contacts the impeller, the movement of the sealing member being actuated by fluid pressure generated at the outlet side of the casing, and wherein the seal is maintained by the continual fluid pressure applied to the sealing member when the pump is in use.

Preferably, the sealing member is slidably mounted in a boss in the casing. In this form, the boss may be in fluid communication with the outlet side of the casing such that the fluid pressure generated at the outlet side of the casing is able to actuate the sealing member to bring it into sealing contact with the impeller.

When the sealing member is mounted in a boss it may be provided as a gasket member which defines a first face adapted to sealingly contact the impeller and a second face adapted to receive the fluid pressure upon which movement of the gasket member is dependent.

The gasket member may be varied provided it is capable of forming a seal. Preferably, the gasket member is generally ring shaped.

The first face may be varied provided it is capable of forming a seal with the impeller. In this regard, when the gasket member is generally ring shaped the first face may have a substantially flat profile and lie substantially perpendicular to the centre-line of the pump. Alternatively and preferably, the first face may include a projection that extends towards and is adapted to contact the impeller.

Preferably, the first face or projecting portion thereof is hardened to improve its wear characteristics and capacity to form a seal. The impeller can also include a hardened insert face for contacting the first face of the gasket member, to also provide improved wear characteristics and capacity to form a seal

The second face may also be varied and may be perpendicular to the centre-line of the pump. Alternatively, the second face may be angled to increase the area upon which the fluid pressure acts.

The sealing member may further comprise a secondary seal. For example, when the sealing member is a ring member it may include a secondary seal located at the inner diameter of the ring member. The secondary seal further assists in preventing seepage from the outlet side of the casing.

The impeller may be varied provided it is compatible with the sealing member in a way that allows a seal to be formed therebetween. Preferably, the portion of the impeller at which the seal is made is hardened to improve its wear characteristics. In one particular form the impeller includes a portion that projects towards the sealing member and defines the site at which the seal is to be formed.

Whilst it is preferable that the sealing member sealingly contacts the impeller it is also possible that an intermediate member may be fitted to the impeller. In this form, the seal is formed between the intermediate member and the sealing member.

In another aspect, the present invention provides a seal assembly for a centrifugal pump for forming a seal between an impeller and its casing, the seal assembly comprising at least one annular sealing member supported on the casing and forming part of the pump inlet, the sealing member capable of movement to a position at which it sealingly contacts the impeller, the movement of the sealing member being actuated by fluid pressure generated at the outlet side of the casing and/or frictional force of fluid moving through the pump inlet, and wherein the seal is maintained by the continual fluid pressure applied to the sealing member and/or continual flow of fluid through the inlet when the pump is in use.

Preferably, the sealing member has a tubular portion received in an annular recess formed in the casing to be movable therealong. The sealing member tubular portion preferably includes an outwardly extending flange at an end thereof adjacent the impeller which extends into a space between the cover and impeller, the space being in fluid communication with the high pressure discharge portion of the casing.

Preferably, an internal diameter face of the sealing member includes a fin, a first ace of the sealing member flange facing away from the impeller includes at least one ramped portion, and the casing cover includes at least one pin located therein for engaging the flange first face and the ramped portion(s), wherein in use, fluid entering the pump undergoing a rotation engages the fin thus rotating the sealing member about its axis which causes the ramped surface(s) to engage the pin(s) to move the sealing member into sealing engagement with the impeller. Preferably, there are the three pins equiangularly disposed around the axis of the casing.

### BRIEF DESCRIPTION OF THE DRAWINGS

The present invention will now be described with reference to the attached drawings which illustrate embodiments of the present invention. The description of the drawings is in no way to limit the generality of the preceding paragraphs.

In the figures;

FIG. 1 is a perspective view of one embodiment of a seal assembly according to the present invention shown forming a seal at the inlet side of the casing of a centrifugal pump;

FIG. 2 is a cross-sectional view of a portion of the pump of FIG. 1 showing a portion of the seal assembly in detail;

FIG. 3 is a more detailed cross-sectional view of the portion of the seal assembly of FIG. 2 showing the seal assembly when the pump is not in use;

FIG. 4 is a cross-sectional view of a second embodiment of a seal assembly according to the present invention shown forming a seal at both the inlet side and opposite side of the casing of a centrifugal pump;

FIG. 5 is a more detailed cross-sectional view of the portion of the seal assembly of FIG. 4, showing the seal assembly when the pump is not in use; and

FIG. 6(a) is a front view of an impeller pump having a third embodiment of a seal assembly according to the present invention;

FIG. 6(b) is a cross-sectional view of the pump of FIG. 6(a) along line A-A thereof showing the seal assembly;

FIG. 6(c) is an enlarged view of the encircled portion of FIG. 6(b) showing the seal assembly when the pump is in use;

FIG. 7(a) is a side view of an impeller pump having a fourth embodiment of a seal assembly according to the present invention;

FIG. 7(b) is a front view of the impeller pump of FIG. 7(a);

FIG. 7(c) is a cross-sectional view of the pump of FIG. 7(b) along line A-A thereof showing the seal assembly;

FIG. 7(d) is an enlarged view of the encircled portion marked B of FIG. 7(c) showing the seal assembly when the pump is not in use;

FIG. 7(e) is a force component diagram showing the discharge forces and suction pressure forces acting on different faces of the sealing member;

FIG. 7(f) is a force component diagram showing the frictional forces acting on the internal face of the sealing member;

FIG. 8 shows a fifth embodiment of a sealing member according to the present invention where (a) shows a perspective view, (b) shows a side view, (c) shows an end view, and (d) shows a side view similar to (b) but rotated about 60° about its axis;

FIG. 9 shows the sealing member of FIG. 8 installed in a casing cover (a) shows a perspective view, (b) shows a side view, (c) shows a front end view, (d) shows a cross-sectional view along line D-D of (c), and (e) shows a cross-sectional view along line E-E of (c);

FIG. 10(a) is a schematic perspective view of the assembly of FIG. 9 and FIG. 10(b) is a partially enlarged view of a mid-portion of FIG. 10(a).

### BEST MODE(S) FOR CARRYING OUT THE INVENTION

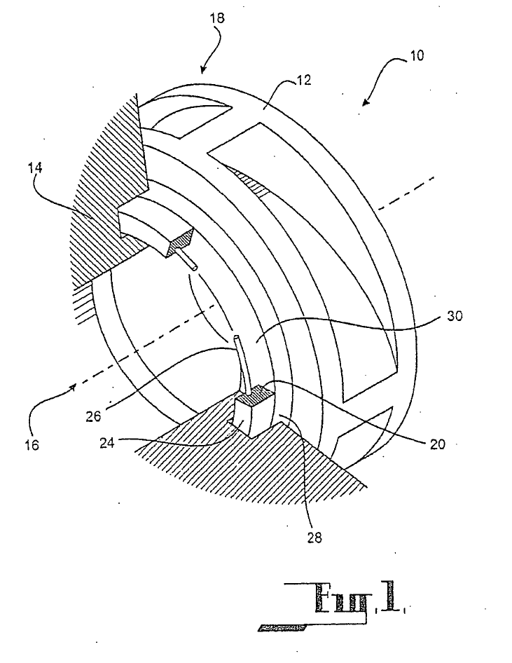

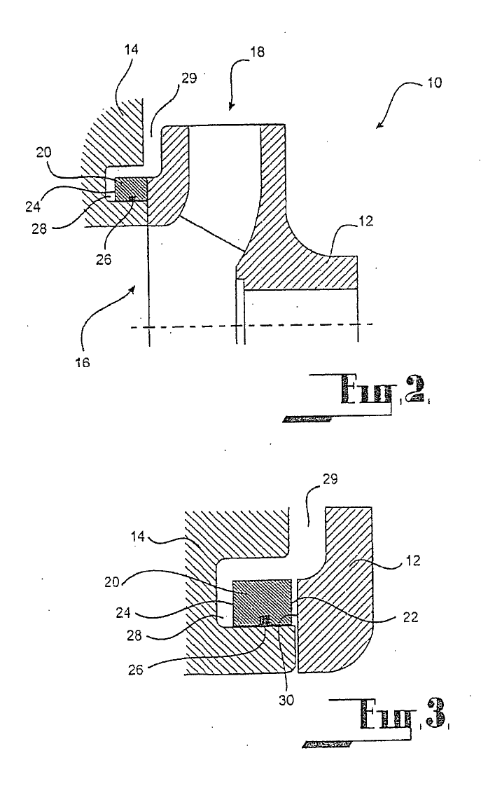

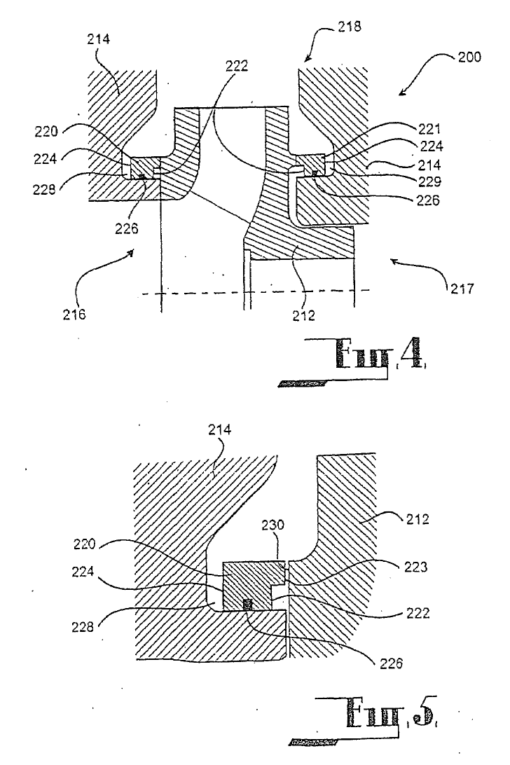

The seal assembly of the first embodiment illustrated in FIGS. 1 to 3 is generally indicated by the numeral 10 and includes a sealing means in the form of a ring member 20 which is adapted to form a seal between an impeller 12 and a casing 14 at the inlet side 16 of the casing 14. The ring member 20 has a first face 22, a second face 24 and a secondary seal in the form of an o-ring 26 located at the inner diameter of the ring member 20. The ring member 20 resides in a machined boss 28 at the inlet side 16 of the casing 14 and is slidably mounted thereon so as to be sealingly contactable with a hardened face 30 of the impeller 12. The machined boss 28 is in fluid communication with the outlet side 18 via a passage 29.

The o-ring 26 assists in preventing seepage of fluid from the high pressure outlet side 18 or discharge side of the casing 14 to the inlet side 16 of the casing 14.

In use, as is known, the impeller 12 is rotated at high speed relative to the casing 14. Fluid is caused to flow from the inlet side 16 and out through the outlet side 18 at high pressure. The ring member 20 is actuated by fluid pressure generated by discharge from the impeller 12 which acts at the second face 24 of the ring member 20 and the first face 22 sealingly contacts the hardened face 30 of the impeller 12. The pressure produced at the outlet side 18, which produces a difference in pressure between the outlet side 18 and the inlet side 16 ensures that the seal between the impeller 12 and the inlet side 16 of the casing 14 is maintained regardless of the wear of either or both of the impeller 12 and the ring member 20.

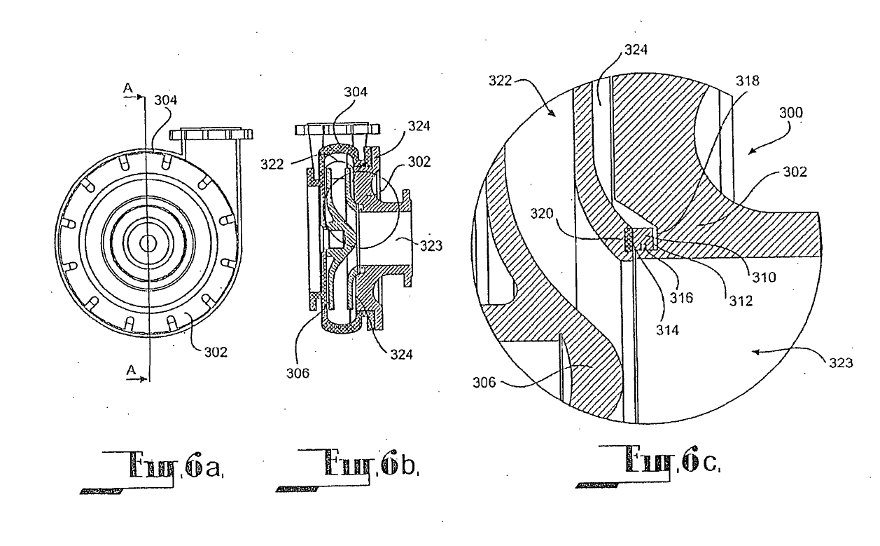

The seal assembly illustrated in FIGS. 4 and 5 is according to a second embodiment of the present invention and is generally indicated by the numeral 200. The seal assembly 200 is adapted to form a seal at both the inlet side 216 and opposite side 217 of the casing 214. The sealing means is provided by a pair of ring members 220, 221. Ring member 220 seals the inlet side 216 of the casing 214 and ring member 221 seals the opposite side 217 of the casing 214.

The ring members 220, 221 have a first face 222 with a projection 223, a second face 224 and a secondary seal in the form of an o-ring 226 located at their inner diameter. The ring members 220, 221 each reside in a machined boss 228, 229 in their respective sides 216, 217 of the casing 214 and are slidably mounted thereon so as to be sealingly contactable with respective hardened faces 230 of the impeller 212.

The o-ring 226 assists in preventing seepage of fluid from the high pressure outlet side 218 or discharge side of the casing 214.

In use, the ring members 220, 221 are actuated by fluid pressure generated by discharge from the impeller 212 which acts at the second faces 224 of the ring members 220, 221 and the projection 223 of the first faces 222 of each ring member 220, 221 sealingly contacts its respective hardened face 230 of the impeller 212.

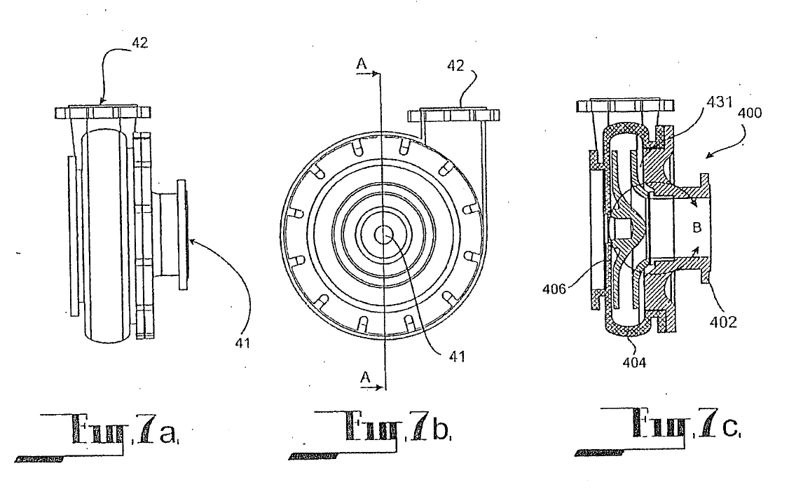

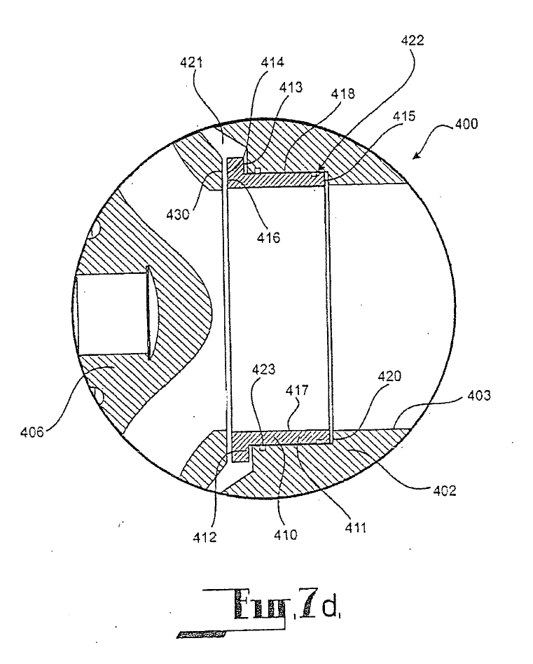

FIGS. 6a to 6c show a third embodiment of a seal assembly according to the present invention and is generally indicated by the numeral 300. The seal assembly 300 is adapted to form a seal between a suction cover 302 of the casing 304 and an impeller 306. The sealing means is provided by a ring member 310 which has a first face 312, a second face 314 and a secondary seal in the form of an O-ring 316 located at its inner diameter. The ring member 310 resides in a machined boss 318 and is slidably mounted thereon so as to be sealingly contactable with a hardened insert face 320 mounted in the impeller 306. The machined boss 318 is in fluid communication with the high pressure discharge portion 322 of the casing 304 via a passage 324.

In use, the ring member 310 is actuated by fluid pressure generated by discharge from the impeller 306 which acts at the second face 312 of the ring members 310 the first face 314 sealingly contacts the hardened insert face 320 of the impeller 306. The o-ring 316 assists in preventing seepage of fluid from the high pressure discharge side 322 into the inlet side 323.

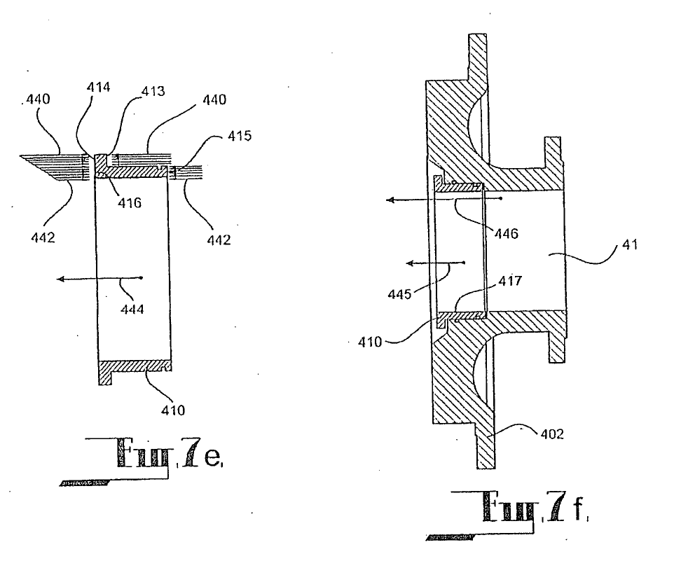

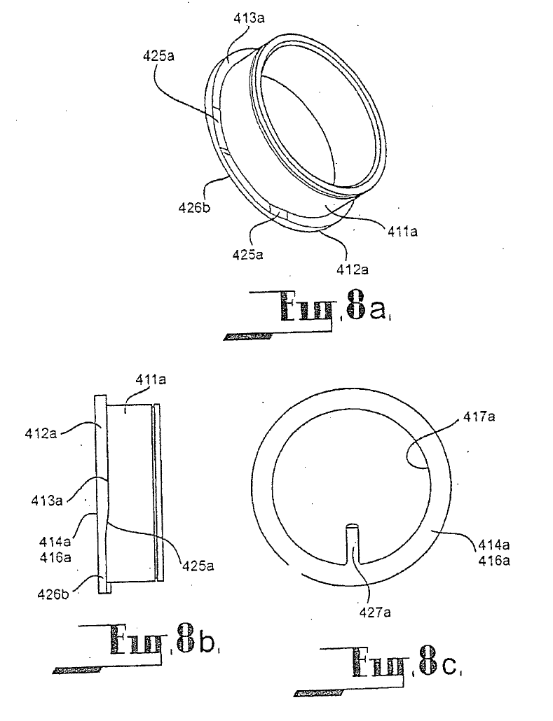

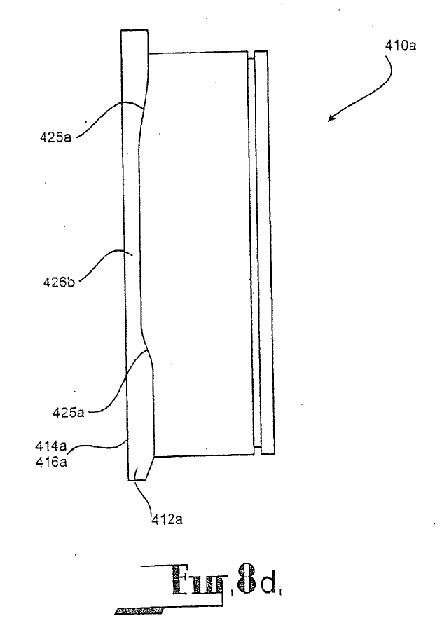

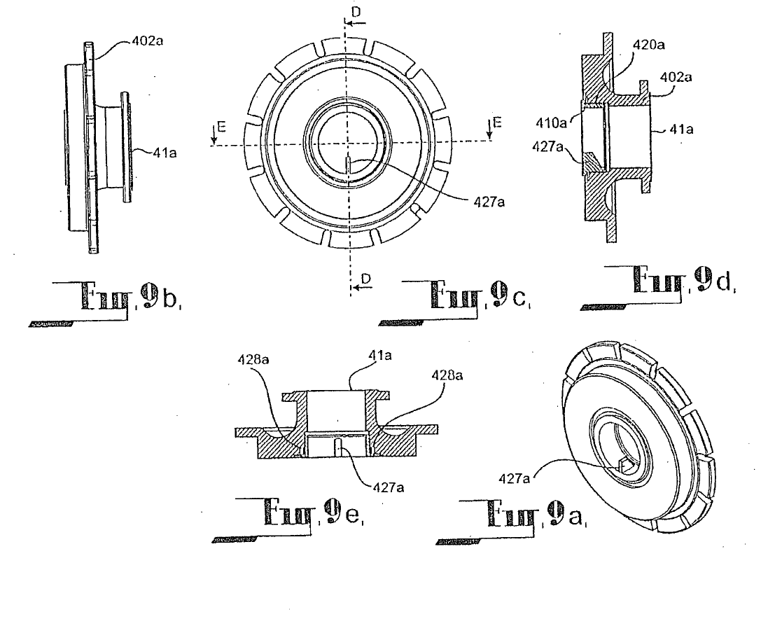

FIGS. 7a and 7b show an impeller pump 40 where suction pressure is generated at inlet 41 and discharge pressure is generated at outlet 42. FIGS. 7c and 7d show a fourth embodiment of a seal assembly according to the present invention applied to the pump 40 and is generally indicated by the numeral 400. The seal assembly 400 is adapted to form a seal between a suction cover 402 of a casing 404 and an impeller 406.

The sealing means is provided by a sealing member 410 having a tubular portion 411 with an outwardly extending flange 412 at an end thereof adjacent the impeller 406. The flange 412 has a first face 413 and a second face 414. The tubular portion 411 has a first end face 415, a second end face 416 co-extensive with the flange second face 414, an internal diameter face 417 and an external diameter face 418.

An annular recess 420 is formed in the internal face of the suction cover 402 for receiving the tubular portion 411 to be movable therealong and such that the internal diameter face 417 is aligned with an internal diameter face 403 of the cover 402. The flange 412 extends into a space 421 between the cover 402 and impeller 406. A first O-ring 422 is located at the external face 418 of the sealing member 410 for engaging the recess 420 and a second O-ring 423 is located in the recess 420 for engaging the external face 418 of the sealing member 410.

As described above, the sealing member 410 is movable towards the impeller 406, such that in use the second faces 414 and 416 are sealingly contactable with a hardened face 430 of the impeller 406. The space 421 is in fluid communication with the high pressure discharge portion 42 of the casing 404 via a passage 431.

In use, high discharge pressure is formed at the outlet 42 and passage 431 while suction pressure is formed adjacent the inlet 41. As shown in FIG. 7e, discharge pressure 440 acts on the flange first face 413, the flange second face 414 and tubular portion second face 416. Suction pressure 442 acts on the tubular portion first face 415 and second face 416. The resultant force as indicated by arrow 444 moves the sealing member 410 for the second faces 414 and 416 to be sealingly engaged with the impeller face 430.

Additionally, as shown in FIG. 7f, frictional forces indicated by arrow 446 generated by fluid moving across the internal diameter face 417 at high velocity results in a resultant force indicated by arrow 445 which further forces the sealing member 410 in the direction for the second faces 414 and 416 to be sealingly engaged with the impeller face 430.

The resultant forces 444 and 445 combine to ensure that the second faces 414 and 416 maintains sealing engagement with the impeller face 430 in use. The O-rings 422 and 423 assist in preventing seepage of fluid from the high pressure discharge space 421 into the inlet 42.

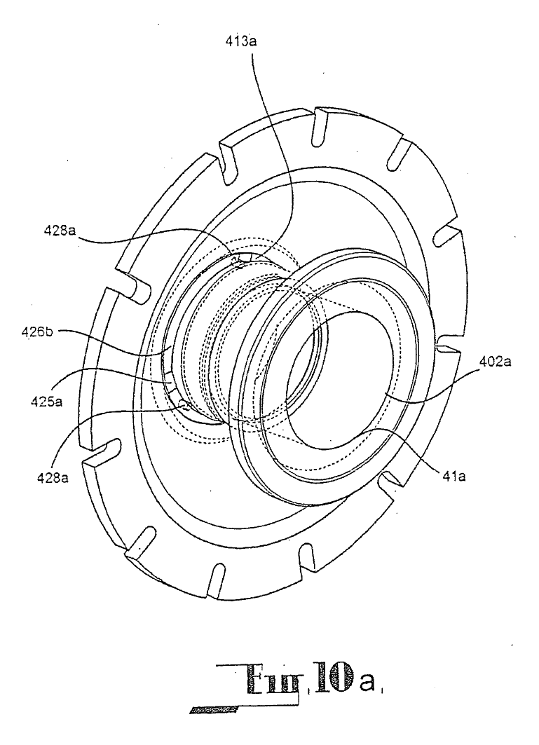

FIG. 8 shows a fifth embodiment of a sealing member 410a which is substantially similar to the sealing member 410 described above. Parts of the sealing member 410a corresponding to those of the sealing member 410 will be referred to with similar numerals but with the suffix “a”. The sealing member 410 has a tubular portion 411a with an outwardly extending flange 412a. The flange first face 413a includes angled or ramped portions 425a which lead to reduced thickness portions 426b of the flange 412a. A fin 427a extends from the internal diameter face 417a. There are three reduced thickness portions 426b spaced around the flange 412a, thus forming six of the ramped portions 425a.

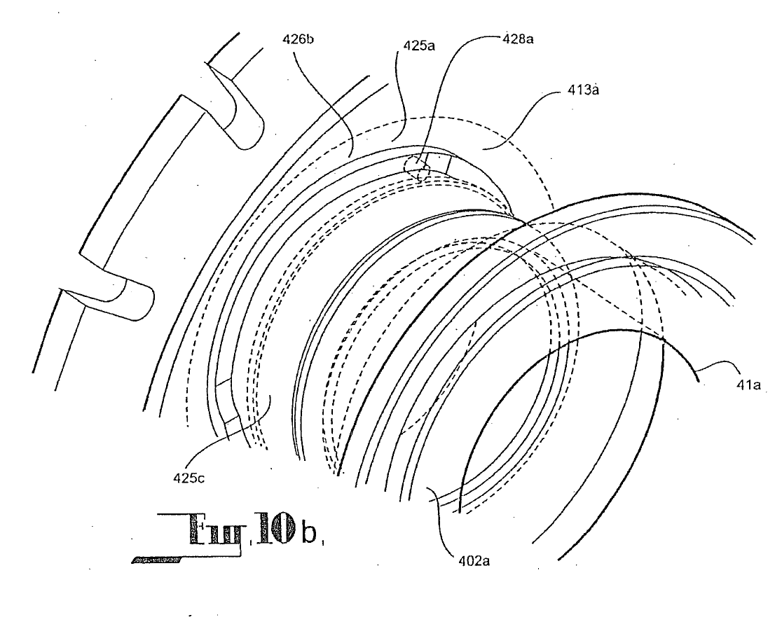

FIGS. 9 and 10 show the sealing member 410a installed an annular recess 420a of a casing cover 402a, similar to the sealing member 410 described above. The sealing member 410a is movable in use towards the impeller, such that in use the second faces 414a and 416a are sealingly contactable with the impeller.

In this embodiment, the casing cover 402a includes three pins 428a located therein for engaging the flange first face 413a, ramped portions 425a and reduced thickness portions 426b. The three pins 428a are disposed equiangularly around the axis of the casing 402a. In use, fluid entering the inlet 41a substantially undergoes a rotation as is typical of centrifugal pumps. The rotating fluid engages the fin 427a thus rotating the sealing member 410a about its axis. This rotation of the sealing member 410a causes the ramped surfaces 425a to engage the pins 428a, thus moving the sealing member 410a such that the second faces 414a and 416a are sealingly engaged with the impeller face.

Providing the pins 428a and the ramped surfaces 425a for moving the sealing member 410a is preferably in addition to, but can be independent of, the movement of the sealing member 410 being actuated by fluid pressure generated at the outlet side of the casing and/or frictional force of fluid moving through the pump inlet as described above in relation to the sealing member 410.

Further modifications and adaptations apparent to one skilled in the art are to be encompassed within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A seal assembly for forming a seal between a first member and a second member, at least one of said members being adapted for rotational movement relative to the other member, the seal assembly comprising a sealing means supported on one of the members and being adapted for movement to a position at which it sealingly contacts the other member, the movement of the sealing means being actuated by fluid pressure.

2. The seal assembly of claim 1 wherein the first member is stationary and the second member is adapted for rotational movement relative to the first member.

3. The seal assembly of claim 2 wherein the sealing means is supported from the stationary first member.

4. The seal assembly of claim 1 wherein both the first and second members are adapted for rotational movement such that there is relative rotational movement between said members.

5. The seal assembly of claim 1 wherein the seal assembly is applied to a centrifugal pump having an impeller that rotates within a casing, the pump having an inlet side for drawing fluid, and an outlet side for discharging the fluid.

6. The seal assembly of claim 5 wherein the first member comprises the pump casing supporting the sealing means and the second member is the impeller and the sealing means is adapted for movement relative to the casing to sealingly contact the impeller, the movement of the sealing means being actuated by fluid pressure generated at the outlet side of the casing.

7. A centrifugal pump seal assembly for forming a seal between an impeller and its casing, the seal assembly comprising at least one sealing member supported on the casing and being capable of movement to a position at which it sealingly contacts the impeller, the movement of the sealing member being actuated by fluid pressure generated at the outlet side of the casing, and wherein the seal is maintained by the continual fluid pressure applied to the sealing member when the pump is in use.

8. The centrifugal pump seal assembly of claim 7 comprising a first sealing member adapted to form a seal at the inlet side of the casing and a second sealing member for forming a seal at an opposite hub side of the casing.

9. The centrifugal pump seal assembly of claim 8 wherein the first and second sealing member are identical.

10. The centrifugal pump seal assembly of claim 7 wherein each sealing member is adapted to sealingly contact the impeller such that the sealing member compensates for wear in either or both of the sealing member and the portion of the impeller at which the sealing member contacts when in use.

11. The centrifugal pump seal assembly of claim 7 wherein each sealing member is slidably mounted in a boss in the casing, the boss being in fluid communication with the outlet side of the casing such that the fluid pressure generated at the outlet side of the casing is able to actuate the sealing member to bring it into sealing contact with the impeller.

12. The centrifugal pump seal assembly of claim 7 wherein each sealing member is provided as a gasket member which defines a first face adapted to sealingly contact the impeller and a second face adapted to receive the fluid pressure.

13. The centrifugal pump seal assembly of claim 12 wherein each gasket member is generally ring shaped.

14. The centrifugal pump seal assembly of claim 12 wherein the first face has a substantially flat profile and lies substantially perpendicular to the centre-line of the pump.

15. The centrifugal pump seal assembly of claim 12 wherein the first face includes a projection that extends towards and is adapted to contact the impeller.

16. The centrifugal pump seal assembly of claim 12 wherein the first face is hardened to improve its wear characteristics and capacity to form a seal.

17. The centrifugal pump seal assembly of claim 12 wherein the impeller includes a hardened insert face for contacting the first face of the gasket member, to provide improved wear characteristics and capacity to form a seal.

18. The centrifugal pump seal assembly of claim 12 wherein the second face is perpendicular to the centre-line of the pump.

19. The centrifugal pump seal assembly of claim 12 wherein the second face is angled to increase the area upon which the fluid pressure acts.

20. The centrifugal pump seal assembly of claim 12 wherein the impeller includes a portion that projects towards the sealing member and defines the site at which the seal is to be formed.

21. The centrifugal pump seal assembly of claim 12 wherein each sealing member further comprises a secondary seal located at the inner diameter of the gasket member to assist in preventing seepage from the outlet side of the casing.

22. The centrifugal pump seal assembly of claim 7 wherein the impeller includes a hardened insert mounted therein for sealingly contacting each sealing member.

23. The centrifugal pump seal assembly of claim 7 further including an intermediate member provided between the impeller and the sealing member wherein the sealing member acts on the intermediate member to form the seal in use between the intermediate member and the sealing member.

24. A seal assembly for a centrifugal pump for forming a seal between an impeller and its casing, the seal assembly comprising an annular sealing member supported on the casing and forming part of the pump inlet, the sealing member capable of movement to a position at which it sealingly contacts the impeller, the movement of the sealing member being actuated by fluid pressure generated at the outlet side of the casing and/or frictional force of fluid moving through the pump inlet, and wherein the seal is maintained by the continual fluid pressure applied to the sealing member and/or continual flow of fluid through the inlet when the pump is in use.

25. The seal assembly of claim 24 wherein the sealing member includes a tubular portion received in an annular recess formed in the casing to be movable therealong, the tubular portion including an outwardly extending flange at an end thereof adjacent the impeller which extends into a space between the casing and impeller, the space being in fluid communication with the high pressure discharge portion of the casing.

26. The seal assembly of claim 25 wherein an internal diameter face of the sealing member is aligned with an internal diameter face of the casing.

27. The seal assembly of claim 24 further including an O-ring located at an external face of the sealing member for engaging the casing.

28. The seal assembly of claims 27 further including a second O-ring located in the casing for engaging the external face of the sealing member.

29. The seal assembly of claim 25 wherein an internal diameter face of the sealing member includes a fin, a first face of the sealing member flange facing away from the impeller includes at least one ramped portion, and the casing cover includes at least one pin located therein for engaging the flange first face and the ramped portion(s), wherein in use, fluid entering the pump undergoing a rotation engages the fin thus rotating the sealing member about its axis which causes the ramped surface(s) to engage the pin(s) to move the sealing member into sealing engagement with the impeller.

30. The seal assembly of claim 29 wherein there are the three pins equiangularly disposed around the axis of the casing.

31. A seal assembly substantially as herein described with reference to FIGS. 1 to 3; FIGS. 4 and 5; FIG. 6(a) to 6(c); FIGS. 7(a) to 7(f); or FIGS. 8(a) to 10(b) of the accompanying drawings.

32. A centrifugal pump substantially as herein described with reference to FIGS. 1 to 3; FIGS. 4 and 5; FIG. 6(a) to 6(c); FIGS. 7(a) to 7(f); or FIGS. 8(a) to 10(b) of the accompanying drawings.
